(19) United States
(12) Patent Application Publication
(10) Pub. No.: US 2012/0284061 A1
(43) Pub. Date: Nov. 8, 2012

(54) INSURANCE WARRANTY PRODUCT, METHOD AND SYSTEM COMPENSATING FOR AN ERROR IN MEDICAL TREATMENT OR NEGATIVE HEALTH OUTCOME

(75) Inventors: Richard A. Collins, Indianapolis, IN (US); Patrick F. Carr, Indianapolis, IN (US); James S. ("Steve") Garrett, Brownsburg, IN (US); James M. Gabriel, Green Bay, WI (US); Kenneth S. Ehlert, Brooklyn Park, MN (US); Mark Pollmann, Brooklyn Park, MN (US)

(73) Assignee: Golden Rule Insurance Company, Indianapolis, IN (US)

(21) Appl. No.: 13/465,168

(22) Filed: May 7, 2012

Related U.S. Application Data
(60) Provisional application No. 61/483,382, filed on May 6, 2011.

(51) Int. Cl. G06Q 40/08

(52) U.S. Cl. 705/4

(57) ABSTRACT

An insurance warranty product provides monetary payment to an insured after experiencing an error in, or negative health outcome resulting from, medical treatment. The terms of the insurance warranty product define the benefit of monetary payment, and the errors in, or negative health outcome resulting from, medical treatment covered by the product may be pre-defined. Errors in medical treatment and negative health outcomes may also be analyzed according to industry standards, and the insured may receive the benefit based on the analysis.

This application claims priority to U.S. Provisional Application No. 61/483,382, filed May 6, 2011, the content of which is hereby incorporated in its entirety by reference.

### FIELD OF THE INVENTION

The present disclosure relates to insurance products that compensate for medical errors. More specifically, an insurance warranty product that provides monetary compensation for an insured experiencing an error in, or negative health outcome resulting from, medical treatment.

### BACKGROUND

Health insurance products typically cover an insured's medical expenses for medical treatments and services. In return for an insured's payment of premiums, the health insurance company provides payment to doctors and healthcare facilities for the medical services rendered to the insured. Where an error in, or a negative health outcome resulting from, medical treatment, occurs, although the insured's medical expenses are typically covered under the insured's health insurance policy, this typical health insurance will not compensate an insured for the effects of the errors or negative health outcomes such as pain and suffering and loss of work. For an insured to obtain such compensation directly from the healthcare provider, the insured usually needs to take legal action directly against the healthcare provider. Such redress may be expensive, uncertain, time consuming and, in many cases, is delayed.

### SUMMARY

An insurance warranty product provided herein monetarily compensates an insured experiencing an error in, or negative health outcome resulting from, medical treatment. The compensation provided by this product may be used by the insured to recoup unanticipated costs and expenses incurred in connection with the medical error or negative health outcome, such as lost wages, pain and suffering, and others. Such a product may provide an insured with a compensation benefit that is in addition to any claim he or she has against the healthcare provider. Moreover, the compensation benefit under the warranty insurance product provides timely compensation to an insured for medical errors or negative health outcomes experienced by the insured.

The present disclosure, in one embodiment, relates to a computer-implemented system for generating insurance data associated with an insurance warranty product providing a benefit for an error in, or negative health outcome resulting from, medical treatment. The system includes a computer processor programmed to: receive data relating to a person or an entity to be procuring the insurance warranty product on behalf of one or more insureds and generate insurance warranty product data based upon the received data. The insurance warranty product data defines terms associated with an insurance warranty product for providing a benefit to the insured in which the insured is monetarily compensated for an error in, or negative health outcome resulting from, medical treatment, and terms under which the insured can claim the benefit. The computer processor is also programmed to determine a premium amount the person or entity is required to pay in order to claim the benefits under the insurance warranty product. An electronic database stores the insurance warranty product data and the premium amount.

In another embodiment, the present disclosure relates to a computer-implemented method for generating insurance data associated with an insurance warranty product providing a benefit for an error in, or negative health outcome resulting from, medical treatment. The method involves receiving data relating to an entity to be insured under the insurance warranty product using a computer processor. Computer processor is also used in the step of generating insurance warranty product data based upon the received data. The insurance warranty product data defines terms associated with an insurance warranty product for providing a benefit to the entity to be insured in which the entity is monetarily compensated for an error in, or negative health outcome resulting from, medical treatment, and terms under which the benefit can be claimed. The computer processor is also used in the step of determining a premium amount the entity to be insured is required to pay in order to claim the benefits under the insurance warranty product. The method includes using an electronic database in the step of storing the insurance warranty product data and the premium amount.

These and other features and advantages of the present disclosure will become apparent to those skilled in the art from the following detailed description, wherein it is shown and described in the illustrative embodiments, including best modes contemplated. As it will be realized, the embodiments are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

FIG. 1 provides a table of examples of surgical, hospital and outpatient medical errors, negative health outcomes, and subsequent actions required to resolve the negative health outcomes according to certain embodiments;

FIG. 2 is a flowchart depicting a computer-implemented method for providing an insurance warranty product according to certain embodiments; and

FIG. 3 is a computing system for implementing the insurance warranty product according to certain embodiments.

### DETAILED DESCRIPTION

According to certain embodiments, an insurance warranty product is provided that pays benefits to an insured when the insured experiences an error in, or negative health outcome resulting from, medical treatment. The insurance warranty product may be implemented for any type of insurance, including but not limited to, health, life, or property insurance.

The insurance warranty product may be created through language included in or associated with a health insurance policy, by language within an attached rider, or may be a stand alone product. A rider attaches to an existing health insurance policy and operates to delete, add, or to delete and replace, i.e., modify, specific provisions within the health insurance policy to which it attaches that relate to the obligations of the insurance company offering the rider. A stand alone product may be purchased separately from a health insurance policy, may be underwritten, or may be guaranteed issue. Insurance warranty products define a provision or right under a warranty provision that, according to certain embodiments, provides the insured with a benefit of monetary payment upon experiencing an error in, or negative health outcome resulting from, medical treatment.

The insurance warranty product may be offered by an insurance company in parallel with the offer of health insurance policies. Thus, in some embodiments, the insurance warranty product may be offered only in conjunction with the purchase of a health insurance policy. Alternatively, the insurance warranty product may be offered to existing health insurance plan members. According to certain embodiments, the insurance warranty product is sold after an underwriting process confirms the applicant is eligible to purchase the health insurance product. Underwriting may proceed in connection with an applicant applying for health insurance, may be performed in connection with an applicant applying for the insurance warranty product, or underwriting may be for applying for both health insurance and the insurance warranty product.

For the purposes of certain embodiments presently described, a policy is composed of features, terms and conditions of a typical health insurance policy, except where the policy would be affected by an insurance warranty product.

Further, for purposes of certain embodiments presently described, a policyholder may include an individual, a corporation, an association, or another qualified group where members are eligible to receive benefits and may individually select the insurance warranty product when another member may not. Such an entity may purchase and exercise benefits under the insurance warranty product.

### Embodiments of Use

The following embodiments of use of the insurance warranty product generally involve an insured experiencing an error in, or negative health outcome resulting from, medical treatment. The terms of the insurance warranty product define whether the error in, or negative health outcome resulting from, medical treatment is one that the insured may receive a benefit for experiencing, and if so, the insured receives a benefit payment from the insurance company.

In one embodiment, an insured under the insurance warranty product undergoes a surgical procedure where a sponge is inadvertently left inside the insured's surgical site. As a result of leaving the sponge behind, the insured develops a postoperative infection and requires surgery to have the sponge removed. Under the terms of the insurance warranty product, leaving a sponge in a surgical site is determined to be an error in medical treatment. The insured contacts the insurance company to report the error in medical treatment, and the insurance company pays the insured the benefit defined under the insurance warranty product. The benefit payable by the insurance company to the insured may vary based on the type and degree of the error in, or negative health outcome resulting from, medical treatment, as described in the section below entitled “Benefit paid to the policyholder or certificateholder.”

In embodiments where the error in, or negative health outcome resulting from, medical treatment is analyzed to determine whether the event falls under the definition of an error in, or negative health outcome resulting from, medical treatment under the insurance warranty product, after the insured submits the claim to the insurance company, the insurance company reviews the medical event before paying the insured any benefit under the insurance warranty policy. Thus, in another embodiment of use, one of a number of possible treatments or medications is delivered to a patient. The patient reacts adversely to the first treatment or medication but is administered a second treatment or medication with no adverse reactions. Because both treatments or medications were acceptable to deliver to the patient, the fact that the first treatment or medication was administered and resulted in a negative health outcome does not necessarily mean administering the first treatment or medication was an error in medical treatment. Thus, according to some implementations, a medical event may not be considered an error in medical treatment where the policyholder received prescribed medical care, but the outcome of the prescribed care did not yield the best possible result. Where the insured submits a claim for a negative health outcome that is determined not to be the result of an error in medical treatment, the insured's claim is denied.

However, according to other embodiments, even where the negative health outcome is not the result of an error in medical treatment, the insured's claim may be paid, for example, where the treatment is characterized as an ineffective treatment but not an error in medical treatment. According to this embodiment, the insured is compensated his monetary benefits, even though the negative medical outcome is not the result of an error in medical treatment.

In another embodiment, errors in medical treatment may be defined under the insurance warranty product according to current industry standards. For example, Medicare employs a policy that defines “never events” including errors in medical treatment that should never happen, such as wrong site surgeries, transfusion of the wrong blood type, pressure ulcers (bedsores) and trauma. Under an insurance warranty product that pays a benefit according to industry standards, where the insured purchases the insurance warranty product prior to the “never events” policy becoming effective, the insured may be paid a benefit after experiencing a negative health outcome due to “never event” error in medical treatment as a result of changing industry standards.

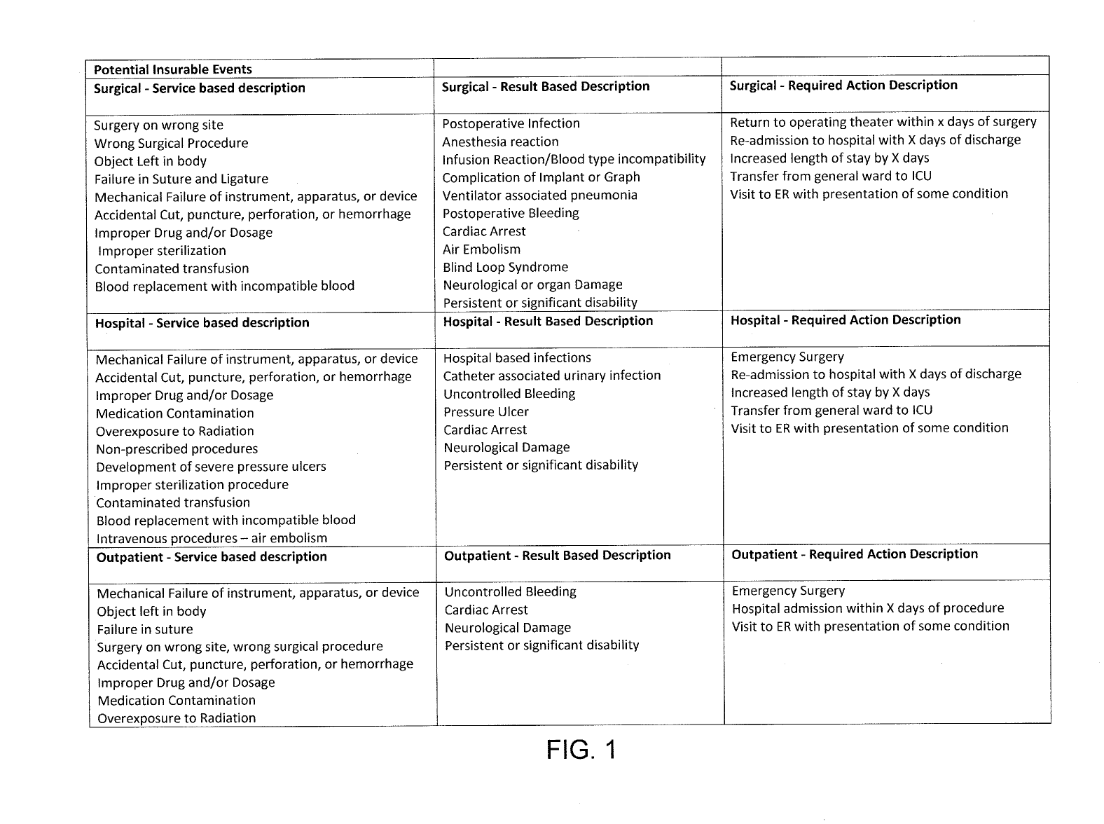

It will be appreciated from the foregoing, that according to certain embodiments, an error in medical treatment defined under the insurance warranty product may be the result of medical malpractice in a surgical, hospital or outpatient setting. For example, FIG. 1 provides a table of examples of surgical, hospital and outpatient errors in medical treatment, their negative health outcomes, and subsequent actions required to resolve the negative health outcomes. An insurance warranty product may pay a benefit to the insured experiencing a negative health outcome or an error in medical treatment listed in FIG. 1. Thus, the insurance warranty product may include pre-defined negative health outcomes or errors in medical treatment for which the benefit will be paid to the insured, examples of which are included in FIG. 1.

In addition or as an alternative to industry standard and/or pre-defined medical errors, the surgical, hospital or outpatient event causing the insured's negative health outcome may be analyzed by the insurance company to determine whether the event falls under the definition of an error in, or negative health outcome resulting from, medical treatment as defined by the terms of the insurance warranty product. Such an analysis may be performed in an automated claims adjudication process, in a manual adjudication process, or in a combination of automatic and manual adjudication.

Moreover, it will be understood that certain exclusions may apply to the paying a benefit to the insured under the insurance warranty product. The exclusions may be defined within the terms of the policy and may include denying benefits for an insured experiencing a medical error from a treating physician that is a family member to the insured. Another exclusion may be denying benefits for an insured experiencing a medical error as a result of requiring medical attention due to an injury suffered while committing a crime or due to a self-inflicted injury. In such cases, the claim for benefit under the insurance warranty product may be analyzed and rejected based on the exclusion.

In a further embodiment of use, the insurance warranty product may additionally include a term that provides the insured with a health care monitoring service. In this embodiment, the insurance company monitors the health care delivered to the insured by, for example, monitoring services and medications administered to the insured. Where an unusual pattern of use is identified by the insurance company, the insurance company notifies the insured of the potential anomaly or problem. In one example, under the insurance warranty product, the insured's prescription data may be reviewed, and based on statistical data or pharmaceutical studies, the insurance company may determine that a negative reaction may occur when one or more of the insured's prescriptions are used together. The insurance company contacts the insured to alert the insured of the potential for an adverse reaction or side effects that may result from combining the prescriptions. Accordingly, the insurance warranty product may additionally provide a preventative component in which the insurance company facilitates prevention of medical errors.

Insurance Warranty Product Pricing and Configuration

Offering an insurance warranty product that pays a benefit to an insured after experiencing an error in, or negative health outcome resulting from, medical treatment requires that the product be designed so that is profitable for the insurance company while being priced so that it is attractive to the consumer. Thus, the design of the insurance warranty product plays a role in whether the product is viable, and a number of complexities are involved in the analysis of creating a product that compensates for errors in, or negative health outcomes resulting from, medical treatment. Such complexities include studying historical data related to the frequency and severity of errors in, or negative health outcomes resulting from, medical treatment and making assumptions on benefit claim incidence based on the data. For example, public historical data related to errors in medical treatment occurring in the population is available from the following studies: John Shreve et al., The Economic Measurement of Medical Errors, Milliman (June 2010); Gawande et al., The incidence and nature of surgical adverse events in Colorado and Utah in 1992, 126 Surgery, 66-75 (July 1999); and Brennan et al., Incidence of adverse events and negligence in hospitalized patients. Results of the Harvard Medical Practice Study I, 324 N. Engl. J. Med., 370-6 (February 1991).

The pricing of the insurance warranty product may vary based on the benefits offered in connection with the insurance warranty product. That is, a number of differently configured insurance warranty products having different premium pricing structures may be available for purchase. For example, when offered in connection with a health insurance policy, the health insurance policy configuration may affect premium pricing and configuration of the insurance warranty product. In particular, health insurance policies may be materially different from one another, e.g., in the number or type of benefits provided to the individual, and as a result, the insurance warranty products offered may be configured and priced differently based on these material differences. In this example, where the health insurance policy providing comparatively fewer benefits, the insurance warranty product offered may be configured to cover the gaps in the health insurance policy, and thus may be priced differently compared to another insurance warranty product configured without regard to gaps that is offered in connection with a health insurance policy offering relatively more benefits. In another example, where a health insurance policy covers medical expenses for follow-up treatments to resolve the insured's negative health consequences resulting from the medical error, an insurance warranty product associated with the health insurance policy may have lower premiums compared to an insurance warranty product that is associated with a materially different health insurance policy that does not pay for follow-up treatments. In a further example, where the health insurance policies are substantially the same or have minor differences between them, the premium pricing and configuration of the insurance warranty product offered in connection with these health insurance policies may also be substantially the same.

Underwriting requirements may also be factored into premium pricing and configuration. For example, applicants undergoing the underwriting process for health insurance and/or for the insurance warranty product may be required to submit answers to questions related to whether the applicant has experienced a medical error, or negative health outcome, in the past, or has had other experiences that may qualify the applicant as a high risk applicant who is more likely to claim benefits under the product. In some cases, applicants with higher rating factors (e.g., those categorized as more likely to claim benefits under the product) are rejected, while in others, the estimated likelihood that the applicant will claim benefits under the product may result in the applicant being offered the insurance warranty product at a comparatively higher premium price. The insurance company may also analyze applicants based on a number of other factors in the underwriting process, including an applicant's age, sex, health status, as well as other factors that may affect the claim frequency under the insurance warranty product and thus form a basis for the premium pricing and plan configuration.

The healthcare provider network servicing insureds may also be a factor in the design and pricing of the product. For example, a healthcare provider network ranked relatively higher than other healthcare provider networks may allow the insurance warranty product to be priced lower due to a lower expected incidence of errors in, or negative health outcomes resulting from, medical treatment.

Other considerations that may play a role in pricing and product design of the insurance warranty product include private historical data on medical error rates retained within the insurance company that offers the product. For insurance warranty policies that cover errors in medical treatment characterized as “never events,” another consideration may be an estimate of the frequency of “never events” and the number of insureds expected to experience such an event and thus claim a benefit under the policy.

The insurance warranty product may also be offered by an insurance company even though the insured pays for health insurance administered by a different insurance company. In this embodiment, the product pricing and configuration may be based on actuarial assumptions.

It will be understood that various considerations in addition or as an alternative to the above-described factors may be taken in combination when designing the insurance warranty product. For example, where the insurance warranty product is offered as an optional addition (e.g., a rider) to a health insurance policy, the underwriting data associated with the health insurance policy and error rate data may be used to calculate pricing of the insurance warranty product.

The premium amount may be a pre-defined, flat amount, or may be proportionate to the insured's health insurance premium, e.g., in situations where the insured has purchased the insurance warranty product in parallel with a health insurance policy.

The premium amount may also be based on whether the insurance warranty product is offered after health insurance underwriting, e.g., the insurance warranty product is offered only to individuals qualifying for health insurance, as opposed to instances where the insurance warranty product is offered without underwriting requirements.

Benefit Paid to the Policyholder or Certificateholder

Under the insurance warranty product, the benefit paid to the insured may be a fixed, pre-defined amount for any experience of loss. Alternatively, the benefit paid to the insured may be fixed within categories of errors of medical treatment, negative health outcomes, and/or subsequent actions required, while each category is associated with a different, fixed benefit paid to the policyholder. For example, FIG. 1 lists the surgical, hospital and outpatient categories of errors of medical treatment, and the amount of the benefit paid may be based on whether the error in medical treatment is categorized as a surgical, hospital or outpatient error.

As will be appreciated, a number of variables may be involved in determining the severity of the error in medical treatment, the negative health outcomes, and subsequent actions. Thus, according to certain implementations, a benefit paid to compensate the insured under the terms of the insurance warranty product may be based on a sliding scale, that takes into account variables used to determine the severity of the error in medical treatment, a negative health outcome, and/or resulting subsequent actions.

The benefit paid under the insurance warranty product may also be calculated by taking into account the factors specific to the insured's experience related to the error in, or negative outcome arising out of, medical treatment. For example, where a first individual experiences an error in medical treatment but completely recovers therefrom, while a second individual does not completely recover from the same error in medical treatment, the benefit paid to the first insured completely recovering may differ from the benefit paid to the second insured that did not completely recover. Thus, according to certain implementations, the insured's recovery, e.g., long-term and/or short-term recovery or prognosis is factored into the benefit paid under the insurance warranty product.

In some implementations, payment of the benefit under the insurance warranty product does not affect the insured's underlying health insurance coverage. The insured's underlying health insurance coverage thus continues to pay healthcare providers for the medical procedures, e.g., for the procedure resulting in the error in medical treatment, the diagnosis of the negative health outcome, and the treatment required to resolve the medical error or negative health outcome. However, in other implementations, receiving compensation under the insurance warranty product may trigger a notification to the insurance company supporting the underlying health insurance policy that may or may not impact the underlying health insurance coverage.

Embodiments may pay a benefit to the insured under the insurance warranty products regardless of the healthcare provider that committed the medical error or negative health outcome, i.e., regardless of whether the provider is an in network provider or an out of network provider. In other embodiments, the healthcare provider is required to be within the healthcare provider network supported by the insurance company administering the insurance warranty product in order for the policy holder to receive the benefit. Alternatively, the benefit paid may be different for a network healthcare provider error compared to an out of network healthcare provider error.

Generally, the insurance warranty product is implemented within a computer system operated by and/or accessed by the insurance company administering the policy. Accordingly, one skilled in the art will appreciate methods described below may be implemented in various computer systems including processors, memory components, databases, hardware, software, network links, and/or server components.

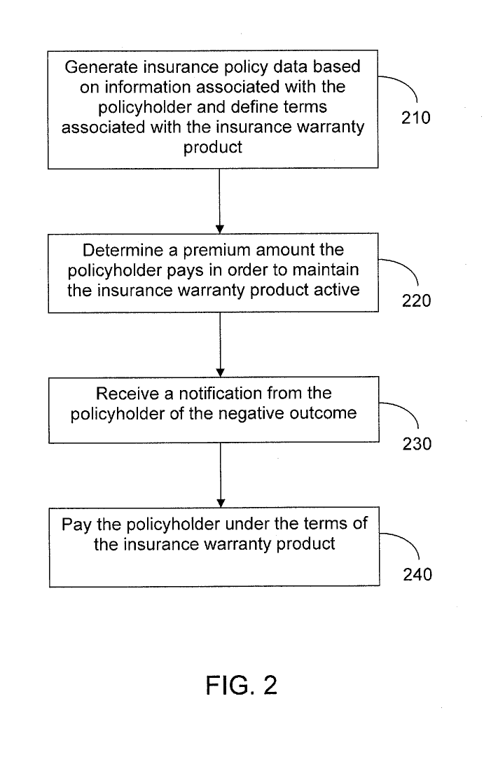

FIG. 2 depicts a flowchart of a computer-implemented method for providing an insurance warranty product. The computer-implemented method involves a processor executing instructions stored in memory, and according to FIG. 2, an insurance warranty product is purchased by an insured, and the processor to generates insurance policy data (210) based on information associated with the insured, such as policy application and underwriting data, and defines terms associated with the insurance warranty product that allows the insured to receive a benefit of payment for experiencing a negative health outcome or an error in medical treatment.

The computer processor determines (220) a premium amount the insured pays in order to maintain the insurance warranty product. By paying the insurance premium amount, the insured's insurance warranty product remains active, and the policyholder has a right to receive the benefit under the defined terms. Premium payment information is stored within an electronic database, which allows the insured's active policy status to be accessed, updated and verified for payment and benefit claiming purposes.

In the event the insured experiences an error in, or negative health outcome resulting from, medical treatment, the insured contacts the insurance company and submits a claim to receive benefits under the insurance warranty product. In the present embodiment, the insurance company receives a notification (230) from the insured of an error in medical treatment or negative health outcome by the insured using a network connection, e.g., via an Internet connection, to submit a claim. Alternatively, the insured notifies the insurance company by phone using an automated system or discusses the claim with an operator that submits information to or accesses the computer system supporting the insurance warranty product. The submitted claim may be analyzed and adjudicated. According to certain embodiments, the claim may be analyzed according to industry standards and may involve determining whether exclusions apply, whether the error in medical treatment occurred within a network of healthcare providers covered under the insurance warranty product, whether the error falls in a category of errors, and/or factors in the entity's recovery from the error in medical treatment.

After processing the submitted claim, the insurance company pays (240) the insured a monetary benefit under the terms of the insurance warranty product. The benefit paid to the insured may be based on the outcome of the various analyses described above, and the monetary compensation may, for example, differ based on a categorization of the error in medical treatment or negative health outcome. According to certain embodiments, the claim is paid only after verifying the error in medical treatment or negative health outcome. Verification may involve accessing the insured's medical records to confirm the error in medical treatment or the negative health outcome. In addition or alternatively, a medical professional may review the records and may examine the insured or contact the treating medical professional to confirm the submitted claim should be paid. In some embodiments, the claims adjudication process under the insurance warranty product follows an insurance claim adjudication process under typical insurance policies, and for example, may be adjudicated manually, automatically or a combination of manual and automatic adjudication.

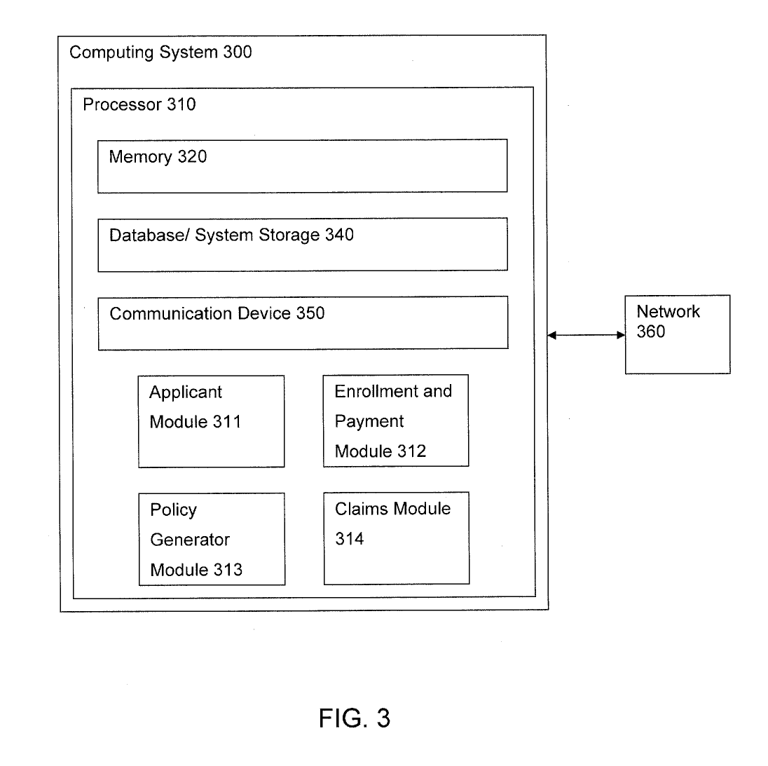

FIG. 3 provides a computing system for implementing the insurance warranty product according to certain embodiments. The computing system 300 includes a number of components operably coupled and includes one or more processors 310 having at least one applicant/insured module 311, an enrollment and payment module 312, and a policy generator module 313, a claims module 314, a memory 320, database/system storage 340, and a communication device 350 for accessing the network 360. The computing system 300, and in particular, the processor 310, may be configured to be accessible by the insurance company, insureds, policy applicants, and system administrators, and data may be entered into the computing system 300.

When accessible by an insured or applicant, the processor 310 may be configured to receive and process application data via the applicant module 311. The processor 310 may be further configured to receive and process enrollment and payment data via the enrollment and payment module 312 so that enrollment and payment data may be entered and accessed by system users such as insureds and insurance company users. The processor 310 may also be configured to generate policy information for the insurance warranty product via the policy generator module 313. When accessible by a user such as an insurance company representative, the processor 310 may be configured to receive and process claim data via the claims module 314. Thus, the modules 311-314 may implement all or a portion of the insurance warranty product described above.

According to further embodiments, the insurance warranty product may be modifiable by updating the computing system 300. The various modules 311-314 of the processor 310 may be configured to be modifiable so that, for example, changes in industry standards that impact the insurance warranty product are updated in the computing system 300. As a result, the modules 311-314 may be configured to implement business rules, and changes or updates to the business rules may modify the operation of the computer-implemented insurance warranty product.

From the above description and drawings, it will be understood by those of ordinary skill in the art that the particular embodiments shown and described are for purposes of illustration only and are not intended to limit the scope of the presently described embodiments. Those of ordinary skill in the art will recognize that the present disclosure may be embodied in other specific forms without departing from its spirit or essential characteristics. References to details of particular embodiments are not intended to limit the scope of the present disclosure.

What is claimed is:

1. A computer-implemented system for generating insurance data associated with an insurance warranty product providing a benefit for an error in, or negative health outcome resulting from, medical treatment, comprising:
a computer processor programmed to:
receive data relating to an entity to be insured under the insurance warranty product;
generate insurance warranty product data based upon the received data, wherein the insurance warranty product data defines terms associated with an insurance warranty product for providing a benefit to the entity to be insured in which the entity is monetarily compensated for an error in, or negative health outcome resulting from, medical treatment, and terms under which the benefit can be claimed; and
determine a premium amount the entity to be insured is required to pay in order to claim the benefits under the insurance warranty product; and
an electronic database for storing the insurance warranty product data and the premium amount.

2. The system of claim 1, wherein the data received is underwriting data.

3. The system of claim 1, wherein the terms pre-define one or more errors in, or negative health outcome resulting from, medical treatment in which the benefits are to be provided to the insured.

4. The system of claim 1, wherein the computer processor is further programmed to analyze a claim for benefit submitted by the entity experiencing an error in, or negative health outcome resulting from, medical treatment.

5. The system of claim 4, wherein the analysis is based on industry standards and benefits are provided to the insured based on an outcome of the analysis.

6. The system of claim 4, wherein the analysis determines whether exclusions apply.

7. The system of claim 4, wherein the analysis determines whether the error in, or negative health outcome resulting from, medical treatment occurred within a network of healthcare providers covered under the insurance warranty product.

8. The system of claim 4, wherein the analysis determines a category of errors the error in medical treatment falls within, and determines the monetary compensation paid to the entity differs based on the categorization of the error in medical treatment.

9. The system of claim 4, wherein the analysis factors in the entity's recovery from the error in, or negative health outcome resulting from, medical treatment and determines the monetary compensation paid to the entity based on thereon.

10. A computer-implemented method for generating insurance data associated with an insurance warranty product providing a benefit for an error in, or negative health outcome resulting from, medical treatment, comprising:
receiving data relating to an entity to be insured under the insurance warranty product using a computer processor;
using the computer processor to generate insurance warranty product data based upon the received data, wherein the insurance warranty product data defines terms associated with an insurance warranty product for providing a benefit to the entity to be insured in which the entity is monetarily compensated for an error in, or negative health outcome resulting from, medical treatment, and terms under which the benefit can be claimed; and
using the computer processor to determine a premium amount the entity to be insured is required to pay in order to claim the benefits under the insurance warranty product; and
storing the insurance warranty product data and the premium amount using an electronic database.

11. The method of claim 10, wherein the data received is underwriting data.

12. The method of claim 10, wherein the terms pre-define one or more errors in, or negative health outcome resulting from, medical treatment in which the benefits are to be provided to the insured.

13. The method of claim 10, further comprising using the computer processor to analyze a claim for benefit submitted by the entity experiencing an error in medical treatment.

14. The method of claim 13, wherein the analysis is based on industry standards and benefits are provided to the insured based on an outcome of the analysis.

15. The method of claim 13, wherein the analysis determines whether exclusions apply.

16. The method of claim 13, wherein the analysis determines whether the error in, or negative health outcome resulting from, medical treatment occurred within a network of healthcare providers covered under the insurance warranty product.

17. The method of claim 13, wherein the analysis determines a category of errors the error in medical treatment falls within, and determines the monetary compensation paid to the entity differs based on the categorization of the error in medical treatment.

18. The method of claim 13, wherein the analysis factors in the entity's recovery from the error in, or negative health outcome resulting from, medical treatment and determines the monetary compensation paid to the entity based on thereon.
